(19) United States
(12) Patent Application Publication
(10) Pub. No.: US 2014/0096002 A1
(43) Pub. Date: Apr. 3, 2014

(54) VIDEO CLIP EDITING SYSTEM

(71) Applicant: FRAMEBLAST LIMITED, London (GB)

(72) Inventors: Aaron Dey, London (GB); Steven Allen, London (GB)

(73) Assignee: FRAMEBLAST LIMITED, London (GB)

(21) Appl. No.: 13/705,053

(22) Filed: Dec. 4, 2012

(30) Foreign Application Priority Data
Sep. 28, 2012 (GB) 1217355.5

(51) Int. Cl. G06F 3/0481

(52) U.S. Cl. CPC G06F 3/04817
USPC 715/723

(57) ABSTRACT

A video clip editing system employs a mobile communication device including computing hardware coupled to data memory, to a touch-screen graphical user interface, and to a wireless communication interface, wherein the computing hardware is operable to execute one or more software applications stored in the data memory. The software applications provide an editing environment on the user interface for editing video clips by user swiping-type instructions for generating a composite video creation, wherein a timeline for icons representative of video clips is presented as a scrollable line feature on the user interface. Icons of one or more video clips for inclusion into the timeline are presented adjacent to the timeline on the user interface, such that video clips corresponding to the icons are incorporated onto the timeline by the user employing swiping-type instructions entered at the user interface for generating the composite video creation.

### FIELD OF THE INVENTION

The present invention relates to video clip editing systems, for example to video clip editing systems based upon using graphical user interfaces of mobile wireless communication devices. Moreover, the present invention also concerns methods of editing video clips, for example to methods of editing video clips using a graphical interface of a mobile wireless communication device. Furthermore, the present invention relates to software products recorded on machine-readable data storage media, wherein the software products are executable upon computing hardware for implementing aforesaid methods.

### BACKGROUND OF THE INVENTION

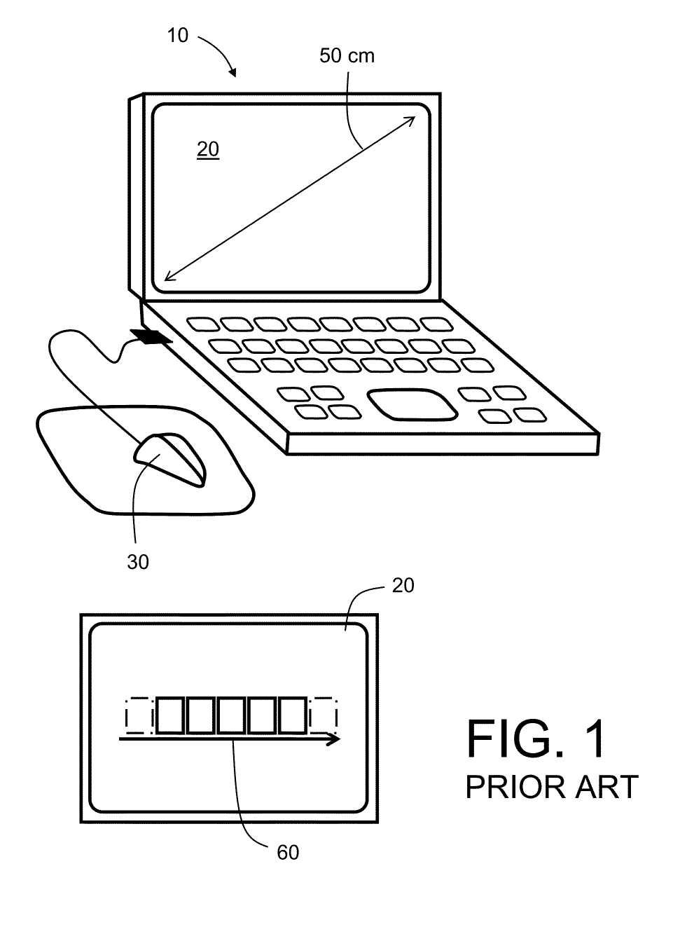

Software products for editing video clips and still pictures to generate video creations, for example for uploading to popular media sites such as YouTube, Facebook and similar (“YouTube” and “Facebook” are registered trademarks), are well known and are executable, as illustrated in FIG. 1, upon a lap-top computer and/or a desk-top computer 10, namely a personal computer (PC), with a graphical display 20 of considerable screen area, for example of 19 inch (circa 50 cm) diagonal screen size, and appreciable data memory capacity, for example 4 Gbytes of data memory capacity, for storing video clips and still pictures. Moreover, the computer 10 includes a high-precision pointing device 30, for example a mouse-type pointing device or a tracker ball-type pointing device. By employing such a high-precision pointing device 30, a given user is able to manipulate icons 50 corresponding to video clips and/or still pictures presented to the given user along a horizontal timeline 60, to control a sequence in which the video clips and/or still pictures are presented when replayed as part of a composite video creation. The given user is also provided with various options presented on the graphical display 20 for adding visual effects, as well as overlaying sound tracks, for example proprietary commercial sound tracks and/or user sound tracks which the given user has stored in the data memory of the computer 10. The high-precision pointing device 30 and the graphical display 20 of considerable screen area provide a convenient environment in which the given user is capable of making fine adjustments when editing the composite video creation to a completed state for release, for example, via aforementioned popular media sites.

Mobile wireless communication devices, for example cell phones, namely referred to as “mobile telephones” in Europe, first came into widespread use during the 1980's. These earlier wireless communication devices provided relatively simple user interfaces including a keyboard for dialing, and a simple display to provide visual confirmation of dialed numbers as well as simple messages, for example short messaging system (SMS) information. Since the 1980's, mobile wireless communication devices have evolved to become more physically compact, and to be equipped with more processing power and larger data memory. Contemporary mobile communication devices are distinguished from personal computers (PCs) by being of a relatively smaller physical size which will fit conveniently into a jacket pocket or small handbag, for example in an order of 10 cm long, 4 cm broad and 1 cm thick.

In comparison to early mobile wireless communication devices, for example cell phones which first became popular in the 1980's, contemporary mobile wireless communication devices, for example “smart phones” or “tablet computers”, have become computationally so powerful that diverse software applications, known as “Apps”, can be downloaded via wireless communication to the contemporary devices for execution thereupon. Conveniently, the Apps are stored on an external database, for example known as an “App store”. User of contemporary wireless communication devices are, for example, to download various Apps from the App store in return for paying a fee. When executed upon computing hardware of the contemporary wireless communication devices, the Apps are capable of communicating data back and forth between the mobile wireless communication devices and other such devices and/or external databases.

A problem encountered with known contemporary mobile communication devices, for example smart telephones, is that their graphical user interfaces (GUI) are contemporary implemented by way of touch-screens of relatively small area which potentially have high pixel resolution but poor pointer-control resolution by way of user finger contact or pointing pen contact onto the touch-screens. As a consequence, it is found extremely difficult for users, especially when their eyesight is impaired and/or their finger dexterity is lacking, for example users of mature age, to download contemporary software applications onto their smart telephones and use the software applications in a manner described in the foregoing for generating composite video compositions. In consequence, users are able to use their smart telephones to capture video dips and/or still pictures, but must then subsequently use a laptop computer and/or desktop computer to edit the captured video dips and/or still pictures to generate composite video creations. Such a process is laborious, frustrating and time consuming for the users.

### SUMMARY OF THE INVENTION

The present invention seeks to provide a video clip editing system which is more convenient for users to employ, wherein the system is based upon users employing their wireless communication devices, for example their smart telephones and/or tablet computers including touch-screen graphical user interfaces, for controlling editing of video clips and/or still picture to generate corresponding composite creations, namely composite video compositions.

Moreover, the present invention seeks to provide more convenient methods of operating a video clip editing system, wherein the methods are based upon users employing their wireless communication devices, for example their smart telephones and/or tablet computers including touch-screen graphical user interfaces, for controlling editing of video clips and/or still picture to generate corresponding composite video creation, namely composite video compositions.

Furthermore, the present invention seeks to provide a software application which is executable upon computing hardware of a contemporary smart mobile telephone and/or tablet computer for adapting the smart mobile telephone and/or tablet computer technically to function in a manner which is more convenient when editing video content to generate corresponding composite video creations.

According to a first aspect of the present invention, there is provided a video clip editing system as defined in appended claim 1: there is provided a video clip editing system employing a mobile wireless communication device including computing hardware coupled to data memory, to a touch-screen graphical user interface, and to a wireless communication interface, wherein the computing hardware is operable to execute one or more software applications stored in the data memory, wherein the one or more software applications are operable when executed on the computing hardware to provide an editing environment on the touch-screen graphical user interface for editing video clips by user swiping-type instructions entered at the touch-screen graphical user interface to generate a composite video creation, wherein a timeline for icons representative of video clips is presented as a scrollable line feature on the touch-screen graphical user interface, and icons of one or more video clips for inclusion into the timeline are presented adjacent to the timeline on the touch-screen graphical user interface, such that video clips corresponding to the icons are incorporated onto the timeline by the user employing swiping-type instructions entered at the touch-screen graphical user interface for generating the composite video creation.

The invention is of advantage in that executing one or more software applications on computing hardware creates an environment enabling swiping-motion inclusion of one or more video clips onto a timeline for generating a composite video creation.

Optionally, for the video clip editing system, the mobile wireless communication device is operable to be coupled in communication with one or more external databases via the wireless communication interface, and manipulation of video clips represented by the icons is executed, at least in part, by proxy control directed by the user from the touch-screen graphical user interface.

Optionally, for the video clip editing system, the one or more software applications when executed upon the computing hardware enable one or more sound tracks to be added to one or more video clips, wherein a duration adjustment of the one or more sound tracks and/or the one or more video clips is executed automatically by the one or more software applications. More optionally, for the video clip editing system, the one or more sound tracks are adjusted in duration without causing a corresponding shift of pitch of tones present in the sound tracks. More optionally, for the video clip editing system, the one or more software applications executing upon the computing hardware are operable to cause the one or more video clips to be adjusted in duration by adding and/or subtracting one or more image frames from the one or more video clips. Yet more optionally, for the video clip editing system, the one or more software applications executing upon the computing hardware synthesize a new header or start frame of a video clip when a beginning part of the video clip is subtracted during editing.

Optionally, for the video clip editing system, the one or more software applications executing upon the computing hardware are operable to provide a selection of one or more video clips for inclusion into the timeline presented adjacent to the timeline on the touch-screen graphical user interface, wherein the selection is based upon at least one of:
(a) temporally mutually substantially similar temporal capture times of the video clips;
(b) mutually similar subject matter content determined by analysis of the video clips or of corresponding metadata; and
(c) mutually similar geographic location at which the video clips were captured.

According to a second aspect of the invention, there is provided a method of editing video clips by employing a mobile wireless communication device including computing hardware coupled to data memory, to a touch-screen graphical user interface, and to a wireless communication interface, wherein the computing hardware is operable to execute one or more software applications stored in the data memory, wherein the method includes:
(a) executing the one or more software applications on the computing hardware for providing an editing environment on the touch-screen graphical user interface for editing video clips by user swiping-type instructions entered at the touch-screen graphical user interface to generate a composite video creation;
(b) generating a timeline for icons representative of video clips as a scrollable line feature on the touch-screen graphical user interface;
(c) generating icons of one or more video clips for inclusion into the timeline adjacent to the timeline on the touch-screen graphical user interface; and
(d) incorporating video clips corresponding to the icons onto the timeline by the user employing swiping-type instructions entered at the touch-screen graphical user interface for generating the composite video creation.

Optionally, the method further includes operating the mobile communication device to be coupled in communication with one or more external databases via the wireless communication interface, and manipulating video clips represented by the icons, at least in part, by proxy control directed by the user from the touch-screen graphical user interface.

Optionally, the method includes enabling, by way of the one or more software applications executing upon the computing hardware, one or more sound tracks to be added to one or more video clips, wherein a duration adjustment of the one or more sound tracks and/or the one or more video clips is executed automatically by the one or more software applications. More optionally, the method includes adjusting a duration of the one or more sound tracks without causing a corresponding shift of pitch of tones present in the sound tracks. More optionally, the method includes executing the one or more software applications upon the computing hardware to cause the one or more video clips to be adjusted in duration by adding and/or subtracting one or more image frames from the one or more video clips. More optionally, the method includes executing the one or more software applications upon the computing hardware to synthesize a new header or start frame of a video clip when a beginning part of the video clip is subtracted during editing.

Optionally, the method includes executing the one or more software applications upon the computing hardware to provide a selection of one or more video clips for inclusion into the timeline presented adjacent to the timeline on the touch-screen graphical user interface, wherein the selection is based upon at least one of:
(a) temporally mutually substantially similar temporal capture time of the video clips;
(b) mutually similar subject matter content determined by analysis of the video clips or of corresponding metadata; and
(c) mutually similar geographic location at which the video clips were captured.

According to a third aspect of the invention, there is provided a software application stored in machine-readable data storage media, wherein the software applications is executable upon computing hardware for implementing a method pursuant to the second aspect of the invention.

Optionally, the software application is downloadable as a software application from an external database to a mobile communication device for implementing the method.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

FIG. 1 is an illustration of a contemporary laptop or desktop computer arranged to execute software products for providing a user environment for editing video clips and/or still pictures to generate corresponding composite video creations;

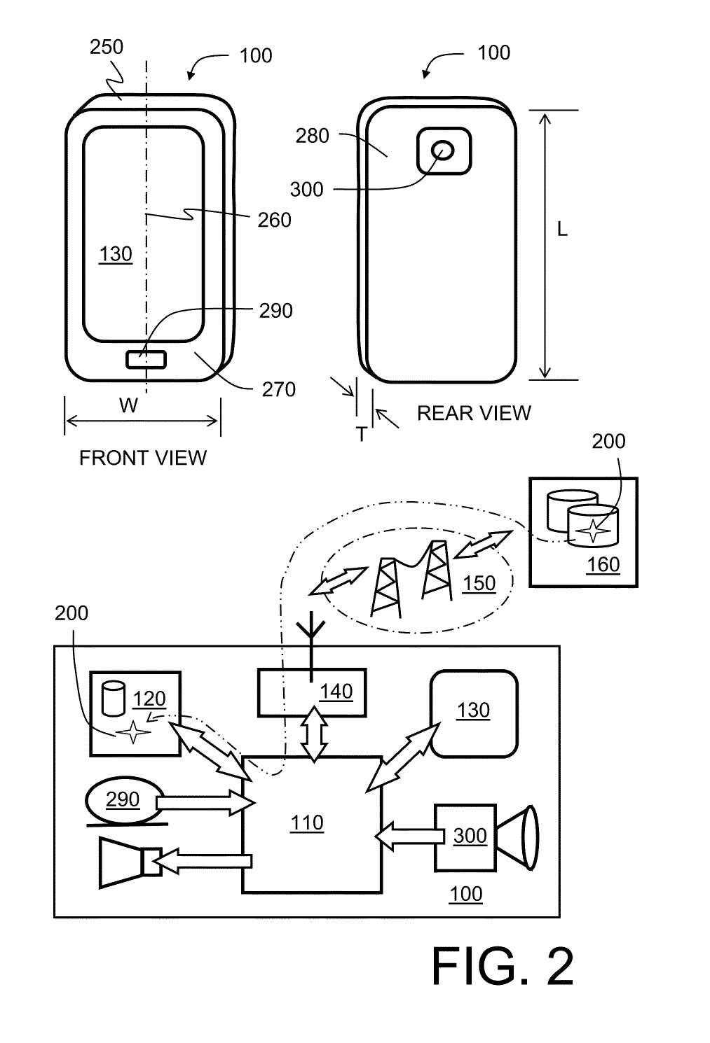

FIG. 2 is an illustration of a contemporary smart telephone or tablet computer which is operable to execute one or more software applications for implementing the present invention;

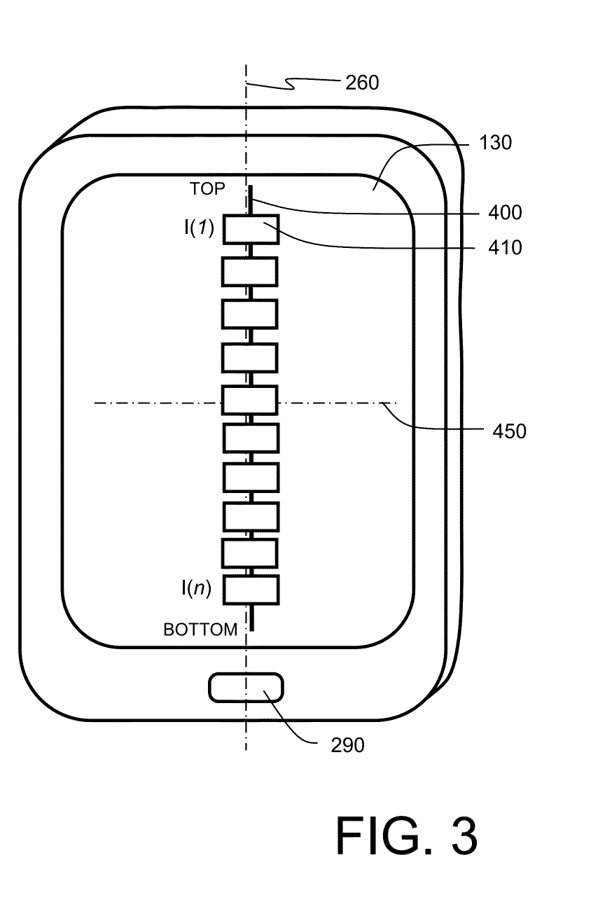

FIG. 3 is an illustration of an editing environment provided on the contemporary smart telephone or tablet computer of FIG. 2;

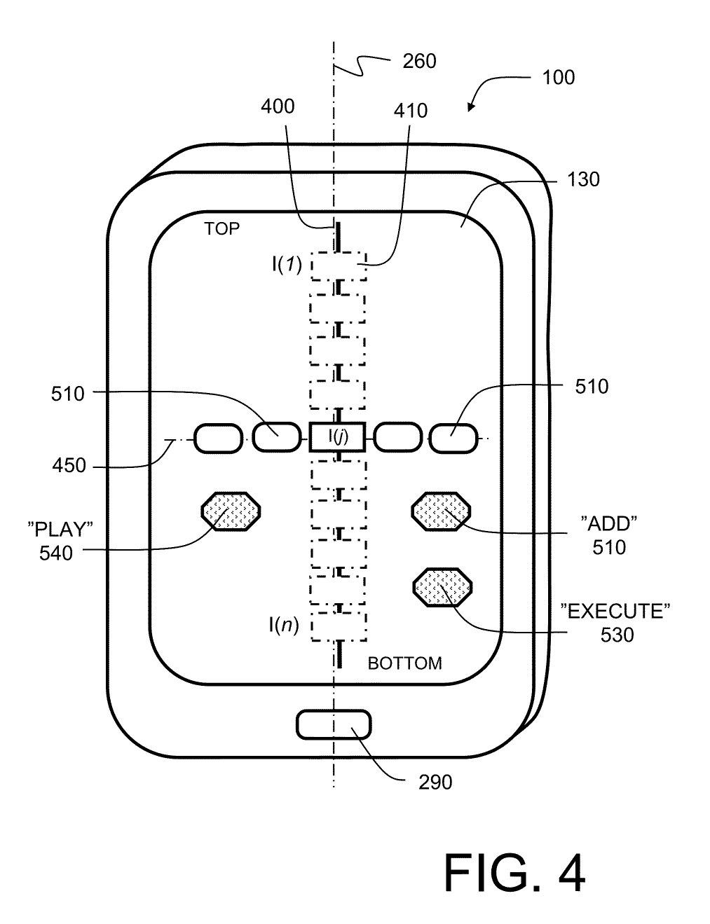

FIG. 4 is an illustration of timeline icons and transverse icons presented to a given user in the editing environment of FIG. 3;

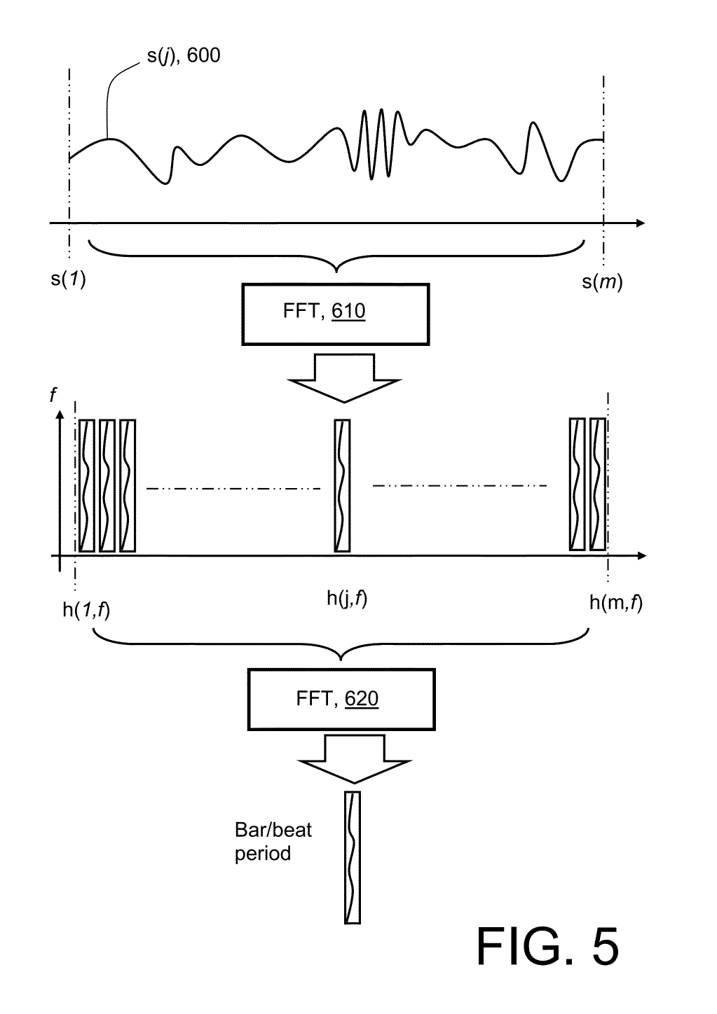

FIG. 5 is an example of sound analysis employed in the smart telephone or tablet computer of FIG. 2;

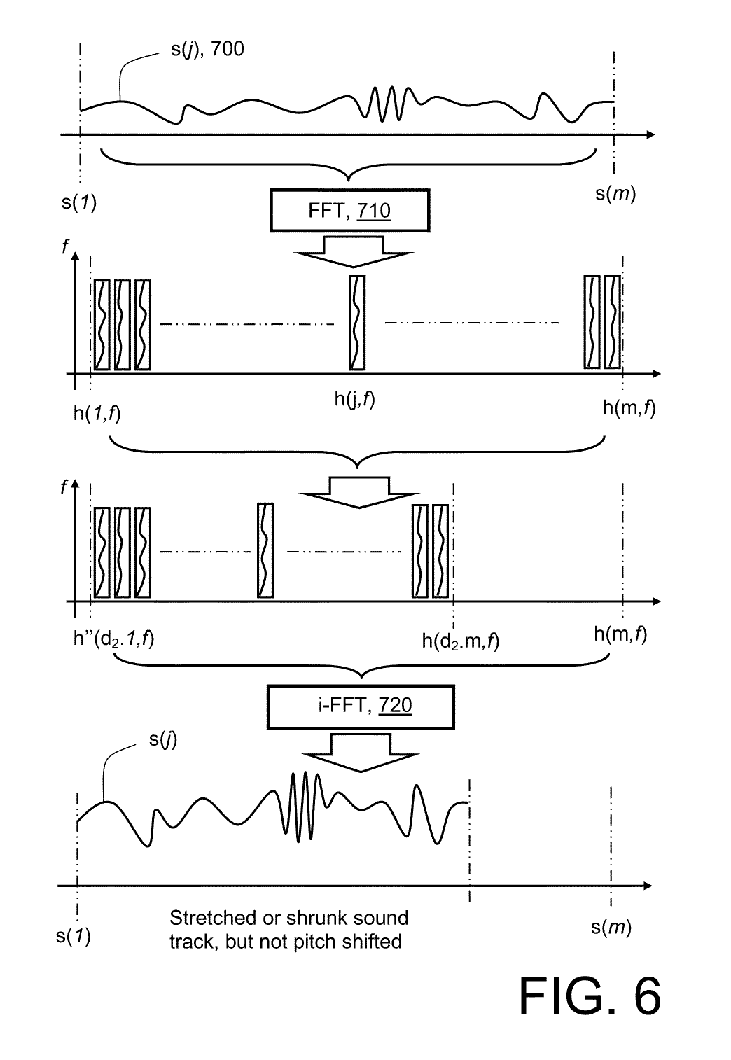

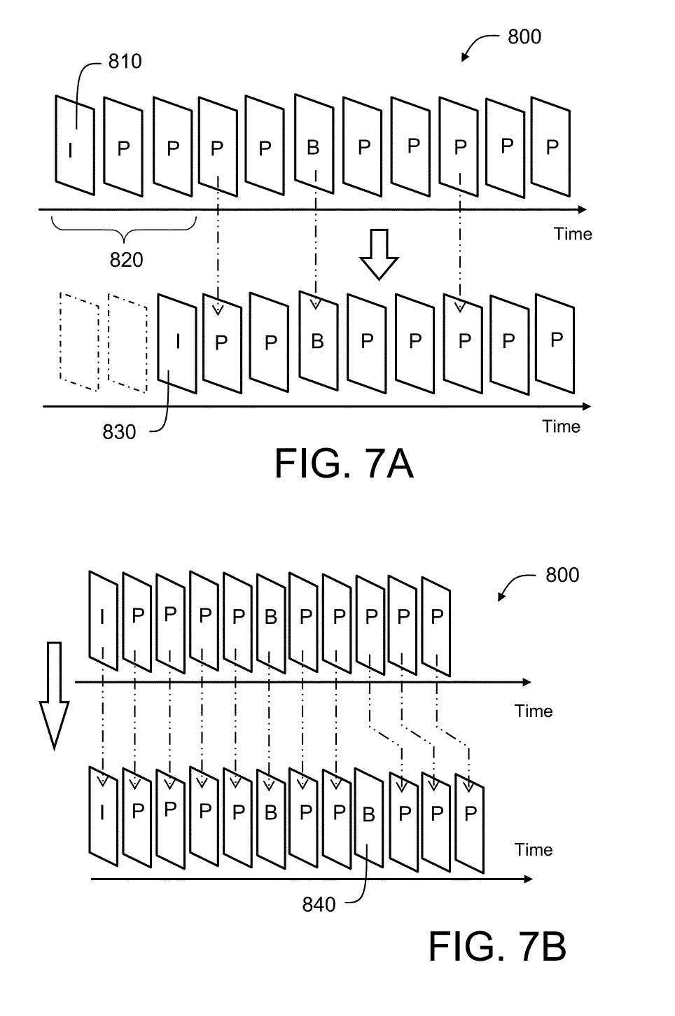

FIG. 6 is an example of sound track editing performed without altering tonal pitch of the sound track;

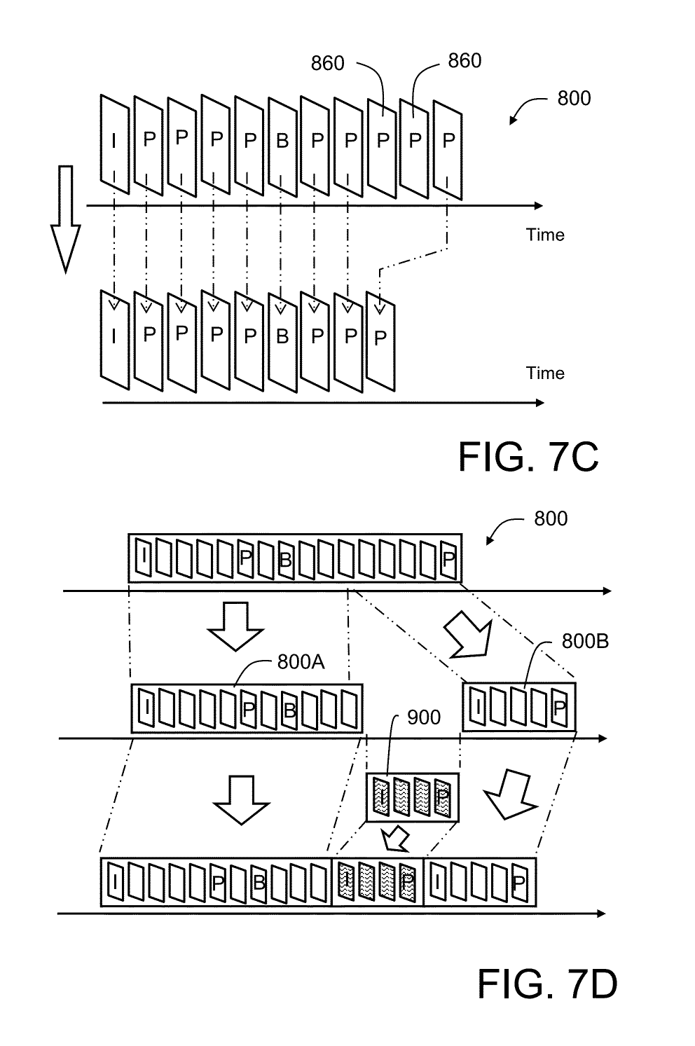

FIG. 7A to FIG. 7D are illustrations of video editing which is implementable using the smart telephone or tablet computer of FIG. 2; and

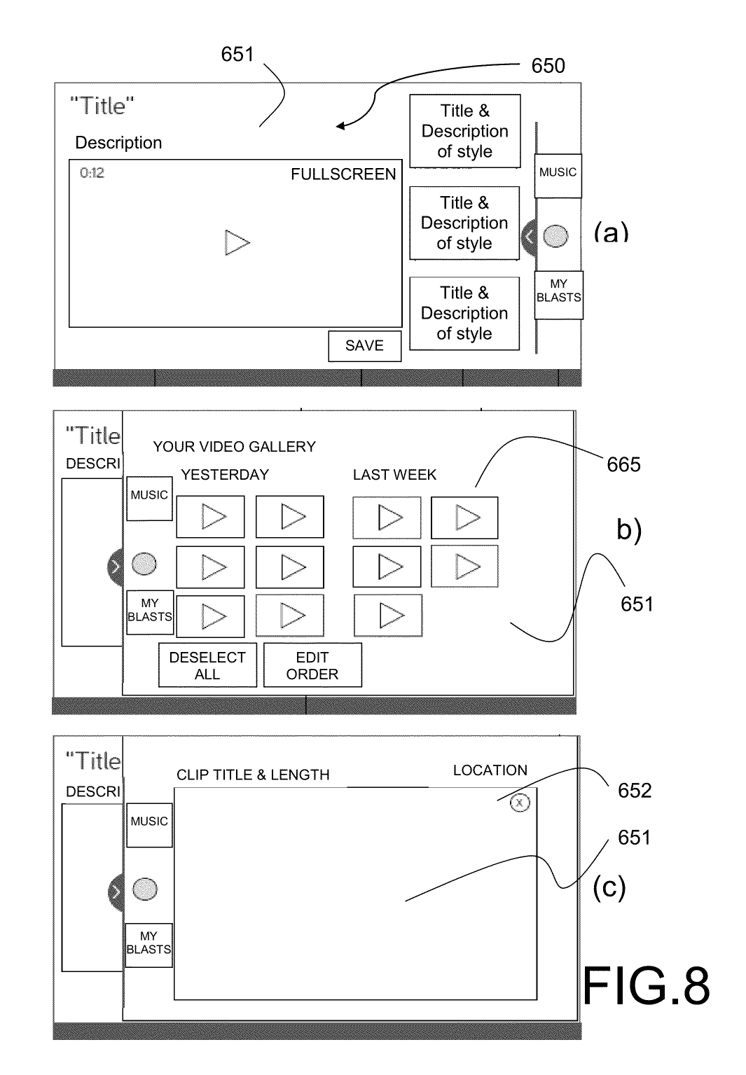

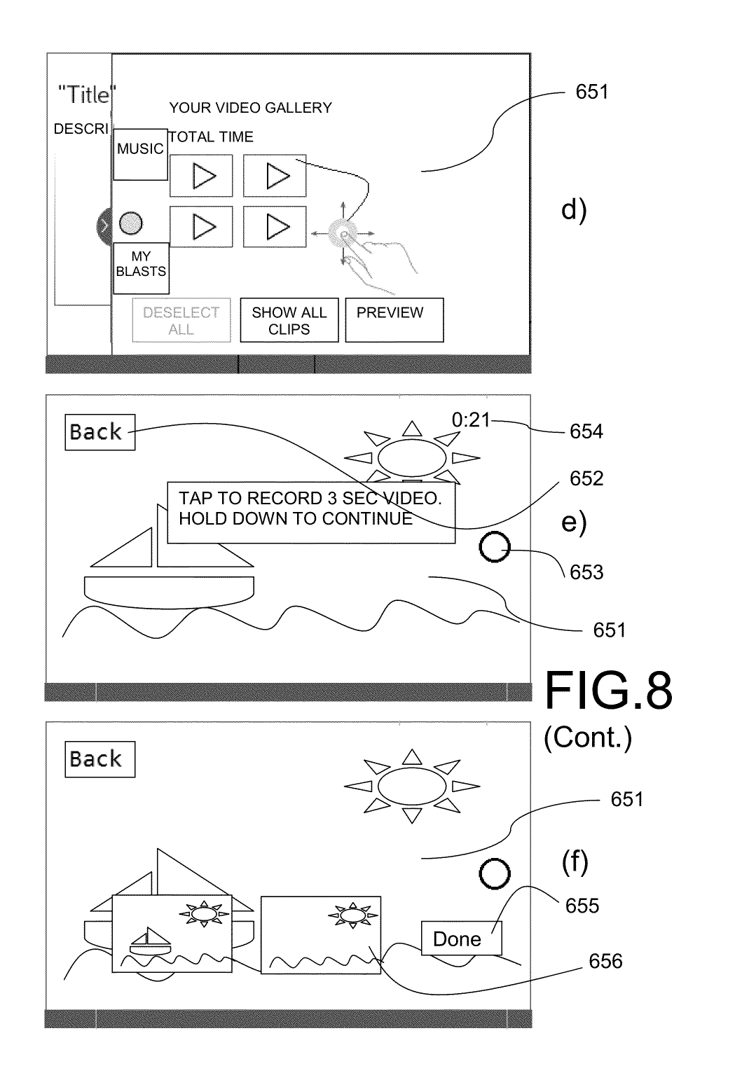

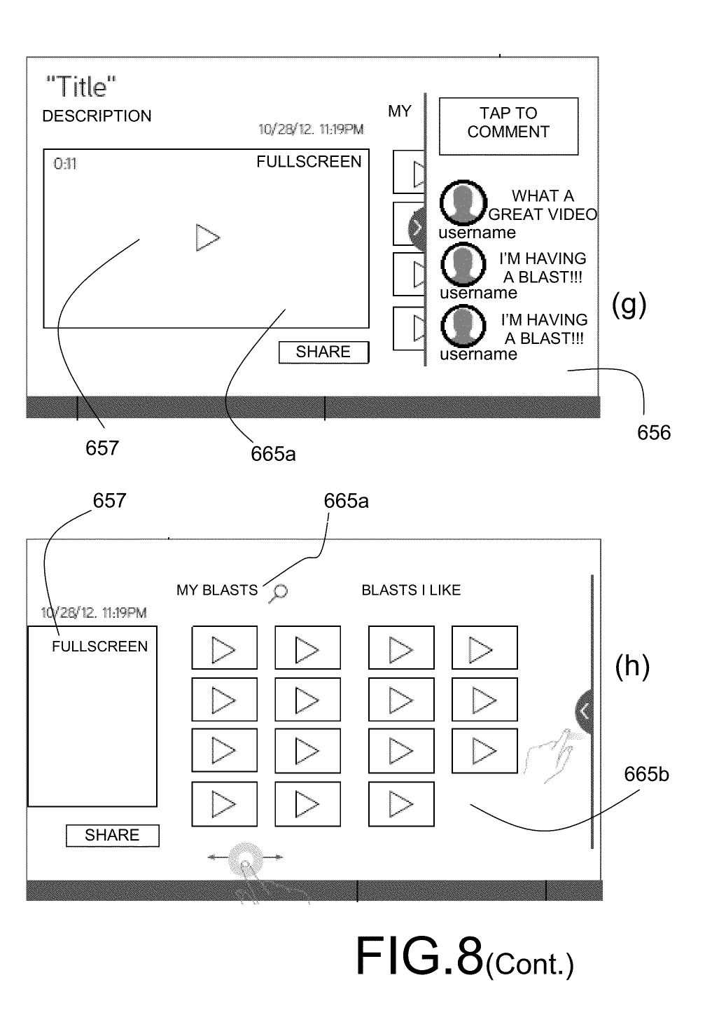

FIG. 8 is an example of video editing and recording using a software application, for example an “App”, using one or more of the smart telephone and/or tablet computer of FIG. 2.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

In overview, referring to FIG. 2, the present invention is concerned with a wireless communication device 100, for example a contemporary smart telephone, for example an Apple iPhone™, a Samsung Galaxy™, an HTC Wildfire™, a Nokia Lumia™, a Sony Xperia™, a Motorola Razr™, and similar, and/or a tablet computer, for example an Apple iPad™, a Google Nexus™, an Amazon Kindle™, a Samsung Galaxy™ and similar, which includes computing hardware 110 coupled to a data memory 120, to a touch-screen graphical user interface 130, and to a wireless communication interface 140. The wireless communication device 100 is operable to communicate via a cellular wireless telephone network 150 and/or optionally via a WiFi network, for example to one or more external databases 160. Moreover, the computing hardware 110 and its associated data memory 120 are of sufficient computing power to execute software applications 200, namely “Apps”, downloaded to the wireless communication device 100 from the one or more external databases 160, for example from an “App store” thereat.

The wireless communication device 100 includes an exterior casing 250 which is compact and generally elongate in form, namely having a physical length dimension L to its spatial extent which is longer than its other width and thickness physical dimensions W, T respectively; an elongate axis 260 defines the length dimension L as illustrated. Moreover, in such contemporary wireless communication devices, it is customary for the devices to have substantially front and rear major planar surfaces 270, 280 respectively, wherein the front major surface 270 includes the touch-screen graphical user interface 130 and a microphone 290, and wherein the rear major surface 280 includes an optical imaging sensor 300, often referred to as being a “camera”. When employed by a given user, the wireless communication device 100 is most conveniently employed in an orientation in which the elongate axis 260 is observed from top-to-bottom by the given user, for example such that the microphones 290 is beneath the touch-screen graphical user interface 130 when viewed by the given user.

A software application 200 for implementing the present invention is preloaded into the data memory 120 of the wireless communication device 100 and/or is downloaded from the one or more external database 160 onto the data memory 120 of the wireless communication device 100. The software application 200 is executable upon the computing hardware 110 to generate an environment for the given user to edit video clips and/or still pictures via the touch-screen graphical user interface 130, namely an environment which is convenient to employ by the given user, despite the limited size and pointing resolution of the graphical user interface 130, which functions in a manner which is radically different to that provided from known contemporary video editing software as aforementioned for use in laptop and desktop computers.

An example user environment presented on the touch-screen graphical user interface 130 by execution of the software application 200 upon the computing hardware 110 will now be described in greater detail. Referring to FIG. 3, there is shown the touch-screen graphical user interface 130 in an orientation as viewed by the given user when executing editing activities pursuant to the present invention; the elongate axis 260 is conveniently orientated from top-to-bottom. The software application 200 executing upon the computing hardware 110 presents a time line 400 from top-to-bottom. This timeline 400 represents a temporal order in which video clips are assembled into a composite video creation. A series of icons 410 presented along the timeline 400 range from an icon I(1) to I(n), where there are n icons 410 corresponding to video clips to be accommodated in the composite creation; optionally, n is so large that not all icons 410 from I(1) to I(n) can be shown simultaneously on the touch-screen graphical user interface 130, requiring a swipe-scrolling action by the given user to examine and manipulate them as will be described later. Optionally, the integer n is initially user-defined; alternatively the given user can add as desired one or more additional icons 410 within the series of icons 410 as required, and given user can also subtract as desired one or more icons 410 from the series of icons 410 as required. By employing a directional finger or thumb swiping motion along the timeline 400 on the touch-screen graphical user interface 130, namely an upwardly-directed swipe or downwardly-directed swipe, the given user can move along the series of icons 410 on the touch-screen graphical user interface 130 to work on a given desired icon 410. The wireless communication device 100 may also be rotated about 90 degrees through its main plane so that the elongated axis 260, previously going from top to bottom in FIG. 3, goes from the right to left (or left to right) i.e. more or less horizontally. The software application 200 then adjusts the User Interface so that the user can operate the functionality in a so called landscape rather than a portrait format. This results in the timeline 400 going from left to right or right to left.

Referring next to FIG. 4, for a given icon 410 scrolled by the given user to align with a transverse axis 450, for example an icon I(i) where an integer i is in a range 1 to n, the software application 200 executing upon the computing hardware 110 is operable to cause a selection of video clips represented as icons 510 to appear which can be inserted by user-selection for inclusion to be represented by the icon I(i). The icons 510 are shown as a traverse series which are scrollable by way the given user performing a transverse finger or thumb swiping motion along the transverse axis 450 on the touch-screen graphical user interface 130. The icons 510 when scrolled are overlaid onto the icon I(i) on the touch-screen graphical user interface 130; the given user can incorporate the video clip corresponding the icon 510 overlaid onto the given icon I(i) by tapping the touch-screen graphical user interface 130 at the icon I(i), else depressing an “add” button area 520 provided along a side of the touch-screen graphical user interface 130. The given user progresses up and down the series of icon 410 until all desired video clips from the icons 510 are incorporated into the icons 410. Incorporation of user-selected icons 510 into the icons 410 as aforementioned causes corresponding movement or linking of video data corresponding to the icons 510. Such linking of video data can occur:
(a) directly in the wireless communication device 100, for example when all the video data corresponding to the icons 510 is present in the data memory 120; or
(b) at the one or more external databases 160 by way of proxy control from the wireless communication device 100, when the video data corresponding to the video clips represented by the icons 510 is present at the one or more external databases 160.
   Again as in FIG. 3 earlier the wireless communication device 100 with the software application 200 in FIG. 4 may be rotated through ca. 90 degrees allowing the functionality in a landscape rather than portrait format for the user.

When the video data corresponding to the icons 510 is present both within the data memory 120 and at the one or more external databases 160, manipulation of video data, for example uploading of video data from the wireless communication device 100 to the one or more external databases 160, is beneficially implemented when the given user has completed a session of editing along the timeline 400, thereby reducing a need to communicate large volumes of data via the cellular wireless telephone network 150, for example by way of the given user depressing an “execute edit” button area 530 of the touch-screen graphical user interface 130.

During manipulation of the icons 410, 510 as aforementioned, the given user can play corresponding video on the touch-screen graphical user interface 130 by tapping the icon 410, 510, alternatively places a desired icon to be played at an intersect of the timeline 400 and the axis 450 and then taps the touch-screen graphical user interface 130 at the insect, alternatively depressing an “play” button area 540 of the touch-screen graphical user interface 130. When the video data corresponding to the selected icon 410, 510 resides in the data memory 120, the computing hardware 110 merely plays a low-resolution version of the selected video content to remind the given user of the content of the video content; alternatively, when the video data corresponding to the selected icon 410, 510 resides in the one or more external databases 160, a low-resolution of the selected video content is optionally streamed to the wireless communication device 100 in real time from the one or more external databases 160.

From the foregoing, it will be appreciated that the software application 200 is capable of providing a high degree of automatic coupling of video clips together to generate the composite video creation. It enables the given user not only to capture video clips using his/her wireless communication device 100, but also enables the given user to compose complex composite video creations from his/her wireless communication device 100; such functionality is inadequately catered for using contemporarily available software applications.

By using artificial intelligence, the icons 510 presented along the transverse axis 450 are chosen by execution of the software application 200 to be in graded relevance, for example one or more of;
(a) a next video clip, or preceding video clip, in temporal capture sequence to video clips preceding or following the icon I(i) along the timeline 400, thus enabling the given user to arrange with ease the video clips along the timeline 400 in a temporal sequence, or reverse temporal sequence, in which they were originally captured;
(b) a next video clip of similar type of video content to video clips preceding or following the icon I(i) along the timeline 400, thus enabling the given user to maintain a given theme in the video clips along the timeline 400 when composing the composite video creation, for example a given video clip I(i) is a picture of the given user's child eating French ice cream, and a next video clip I(i+1) along the timeline 400 presented as an option along the transverse axis 450 is a video clip of the Eiffel Tower in Paris, for example derived from a common database of video clips maintained at the one or more external databases 160;
(c) a next video clip proposed along the transverse axis 450 is captured from a generally similar geographical area as pertaining to video clips preceding or following the icon I(i) along the timeline 400, for example determined by the video clips having associated therewith metadata including GPS and/or GPRS position data which can be searched for relevance;
(d) one or more sound tracks proposed along the transverse axis 450, for example one or more music tracks, to be added to the video clip selected by the given user for the icon I(i); the one or more sound tracks can be those captured by the given user, alternatively for example derived from a common database of sound tracks maintained at the one or more external databases 160; and
(e) special effects to be added to the video content associated with the icon I(i), for example text bubbles, static exclamation symbols, animated exclamation symbols, geometric shapes to mask out certain portions of the video clip (for example for decency or anonymity reasons).

Combining video clips and additional sound tracks in respect of the icon I(i) is a non-trivial tasks, in view of the video clips being of temporally mutually different duration. The touch-screen graphical user interface 130 does not provide the given user with sufficient adjustment precision to try to edit the sound track or video clip, and hence the software application 200, for example with assistance of proxy software applications executing at the one or more external databases 160, is required to add sound to video clips in an automated manner which provides a seamless and professional result. Such addition is beneficially achieved using one or more of following techniques:
(i) F1: by fading the sound track in and out towards a beginning and an end of the video clip respectively;
(ii) F2: by cutting the music track on a music beat, for example switching to the subsequent video clip along the timeline 400 is achieved at the music beat; and
(iii) F3: by temporally stretching and/or shrinking one or more of the video clip and the music track so that they mutually temporally match.

Options (ii) and (iii) require special data processing techniques which will now be elucidated in greater detail. In general, speeding up or slowing down an sound track, even by only a few percent, can alter radically an aesthetic impression of users to the music track, as tonal pitches in the sound track are corresponding shifted; in consequence, the present invention is susceptible to being implemented most simply by modifying the video clip itself, for example by insertion of duplicate video images into the video clip, or removal of video images from the video clips, or a combination of such insertion and removal of video images.

Beat analysis of a sound track will next be described with reference to FIG. 5. The software product 200, alternatively corresponding software executing upon the one or more external databases 160 and controlled by proxy from the wireless communication device 100, are operable to load a given sound track 600 to be analysed into data memory, for example into the data memory 120 or corresponding proxy memory at the one or more external databases 160. The sound track 600 is represented by a signal s(j) which has signal values s(1) to s(m) from its beginning to its end, wherein j and m are integers, and j represents temporal sample points in the signal s(j) and has a value in a range from 1 to m. The signal s(j) typically has many hundred thousand sample points to many millions of sample points, depending upon temporal duration of the signal s(j) from 1 to m. Optionally, the signal s(j) is a multichannel signal, for example a stereo signal. The signal s(j) is subjected to processing by the software application 200 executing upon the computing hardware 110, alternatively or additional by corresponding software applications at the one or more external databases 160 under proxy control of the wireless communication device 100, to apply temporal bandpass filtering denoted by 610 using digital recursive filters and/or a Fast Fourier Transform (FFT) to generate an instantaneous harmonic spectrum h(j, f) of the signal s(j) at each sample point j along the signal s(j), wherein h is an amplitude of a harmonic component and f is a frequency of the harmonic component as illustrated in FIG. 5. Certain instruments such as cymbals and bass drums defining beat generate a particular harmonic signature which occurs temporally repetitively in the harmonic spectrum h as a function of the integer j. For example, a period of the harmonic signature of the certain instruments defining beat can be determined by subjecting the harmonic spectrum h(j, f), for a limited frequency range f₁ to f₂ corresponding to the harmonic signature of such instruments, to further recursive filtering and/or Fast Fourier Transform (FFT), denoted by 620, as a function of the integer j to find a duration of the beat, namely bar, from a peak in the spectrum generate by such analysis 620. When a duration of a bar in the music signal s(j) has been determined, the signal s(j) can then be cut by the software application 200 executing upon the computing hardware 110, alternative by proxy at the one or more external databases 160, to provide automatically an edited sound track which is cut cleanly at a beat or bar in the original music track represented by the signal s(j) typically. Such an analysis approach can also be used to loop back at least a portion of the sound track to extend its length, wherein loopback occurs precisely at a beat or bar-end in the music track.

Optionally, the analysis 610 also enables the music track 600 to be analysed whether or not it is beat music or slowly changing effects music, for example meditative organ music having long sustained tones, which is more amenable to fading pursuant to aforesaid technique F1.

Changing a speed of the sound track without changing its tonal pitch will next be described with reference to FIG. 6. The software product 200, alternatively corresponding software executing upon the one or more external databases 160 and controlled by proxy from the wireless communication device 100, are operable to load a sound track 700 to be analysed into data memory, for example into the data memory 120 or corresponding proxy memory at the one or more external databases 160. The sound track 700 is represented by a signal s(j) which has signal values s(1) to s(m) from its beginning to its end, wherein j and m are integers, and j represents temporal sample points in the signal s(j) and has a value from 1 to m. The signal s(j) typically has many hundred thousand sample points to many millions of sample points, depending upon temporal duration of the signal s(j) from 1 to m. Optionally, the signal s(j) is a multichannel signal, for example a stereo signal. The signal s(j) is subjected by the software application 200 executing upon the computing hardware 110, alternatively or additional by corresponding software applications at the one or more external databases 160 under proxy control of the wireless communication device 100, to apply temporal bandpass filtering denoted by 710 using digital recursive filters and/or a Fast Fourier Transform (FFT) to generate an instantaneous harmonic spectrum h(j, f) of the signal s(j) at each sample point j along the signal s(j), wherein h is an amplitude of a harmonic component and f is a frequency of the harmonic component as illustrated in FIG. 6. By representing the harmonic spectra h(j, f) as corresponding temporal data spectrum h′(d_{1·}j, f), wherein d₁ is a temporal period between samples when sampling the sound track 700, a slowed-down or speeded up sound track is represented by h″(d_{2·}j, f), wherein d₁ and d₂ are mutually different. The duration d₂ can be chosen so the sound track h″(d_{2·}j, f), when subject to an inverse Fast Fourier Transform (i-FFT), denoted by 720, is of similar duration to a video clip, or series of video clips, to which the sound track h″(d_{2·}j, f) is to be added. By such a technique F2, matching of temporal durations of sound tracks and one or more video clips can be matched for purposes of being mutually added together using the software application 200 and/or corresponding proxy software at the one or more external databases 160. Such a technique enables a speed of the music track 700 to be changed for editing purposes without altering pitch of tones present in the music track 700. Optionally, the software application 200 allows the given user to alter the tempo of the music track within a duration of the music track, for example to slow down the music track at a time corresponding to a particular event occurring in the video clip for artistic or dramatic effect to make the composite video creation more exciting or interesting for subsequent viewers therefore, for example when the composite video creation is shared over aforesaid social media, such slowing down or speeding up of tempo of the music track without altering the frequency of tones in the music track is not a feature provided in contemporary video editing software, even for lap-top and desk-top personal computers.

As an alternative, or addition, to editing automatically features of sound tracks, the software application 200 is capable of processing video clips to extend their length or shorten their length for rendering them compatible in duration with sound tracks, for removing irrelevant or undesirable video subject matter and similar. Referring to FIG. 7A to FIG. 7D, the software application 200, or corresponding software applications executing at the one or more external databases 160 under proxy control from the software application 200, when executed upon the computing hardware 110 are operable to enable a video clip 800 to be manipulated in data memory, for example in the data memory 120. The video clip 800 includes a header frame 810, for example an initial I-frame when in MPEG format, and a sequence thereafter of dependent frames, for example P-frames and/or B-frames when in MPEG format. When editing by shortening a beginning portion 820 of the video clip 800 as illustrated in FIG. 7A, a new header frame 830 is synthesized by the software application 200 or its proxy as aforementioned. When editing by extending a duration of the video clip 800, additional frames are added which cause the video clip 800 to replay more slowly, or momentarily pause, for example by adding one or more P-frames and/or B-frames 840 when in MPEG format; this is illustrated in FIG. 7B. Optionally, the added one or more P-frames and/or B-frames correspond to causing the video track 800 to loop back along at least a part of its sequence of images. When editing by shorting a duration the duration of the video clip 800, for example as illustrated in FIG. 7C, one or more frames 860 are removed from video clip 800 after its initial header 810, for example one or more B-frames or P-frames when in MPEG format, and remaining abutting frames either side of where the one or more frames have been removed are then amended to try to cause as smooth a transition as possible between the abutting frames; this is experienced when the video is replayed as a momentary visual jerking motion or sudden angular shift in a field of view of the video clip. As illustrated in FIG. 7D, the video clip 800 can also be extended using the software application 200 and/or corresponding software applications executing at the one or more external databases 160 under proxy control from the software application 200, by inserting supplementary subject matter 900, for example experienced when viewing the video clip as an still image relevant to the subject matter of the video clip 800; for example, the video clip 800 is taken along a famous street in Stockholm, and then a brief picture of Gamla Stan in Stockholm is briefly shown for extending a duration of the video clip 800. Optionally, the software application 200 selects the inserted subject matter 900 from metadata associated with the video clip 800, and/or by analysing the video clip 800 to find related subject matter, for example by employing neural network analysis or similar. The subject matter 900 is inserted into the video clip 800 by dividing the video clip 800 into two parts 800A, 800B, each with their own start frame, for example each with its own I-frame when implemented in MPEG, and then inserting the subject matter 900 as illustrated between the two parts 800A, 800B.

The software application 200 is thus capable of executing automatic editing of video clips and/or sound tracks so that they match together in a professional manner, wherein such automation is necessary because the a touch-screen graphical user interface 130 provides insufficient pointing manipulation accuracy and/or viewed visual resolution, especially when the given user has impaired eyesight, to enable precise manual editing operations to be performed. However, despite its sophisticated image and sound processing algorithms, the software application 200 and/or its proxy may not always achieve an aesthetically perfect edit; beneficially, along the transverse axis 430, the software application 200 is operable to present the given user with a range of aforementioned edits to match video clips and sound tracks together, for example generated using a random number generator to control aspects of the editing, for example where frames are added or removed, where a music track is cut at an end of a music bar selected, at least in part depending upon a random number, so that the given user can select amongst the proposed edits implemented automatically by the software applications 200 to select a best automatically generated edit. Optionally, the series of edits proposed by the software application 200 and/or its proxy, are filtered for highlighting types of edits which the software application 200 recognizes to be in a taste of the given user, for example based upon an analysis of earlier choices made by the given user when selecting amongst automatically suggested editing video clips and sound tracks, for example by way of neural network analysis of the given users earlier choices. In other words, the software application 200 is capable of operating in an adaptive manner to the given user.

When the given user has completed generation of the composite video creation, stored at least in one of the data memory 120 and one or more external databases 160, the given user is able to employ the software application 200 executing upon the computing hardware 110 to send the composite video creation to a web-site for distribution to other users, and/or to a data store of the given user for archival purposes. The web-site for distribution can be, for example, a social media web-site, or a commercial database from which the composite video creation is licensed or sold to other uses in return for payment back to the given user. The present invention thereby enables the given user both to capture video clips and sound tracks using his/her wireless communication device 100, for example smart telephone or tablet computer, as well as using his/her wireless communication device 100 to edit the video clips and sound tracks to generate composite video creations for distribution, for example in return for payment. As a result, the present invention is pertinent, for example, to poorer parts of the World where the given user may be able to afford the wireless communication device 100, but cannot afford in addition a lap-top computer or desk-top computer. By generating composite video creations using their smart telephones or tablet computers, such users from poorer parts of the World are able to become “film producers” and thereby vastly increase a choice of video content available around the World to the benefit of humanity as a whole.

In FIG. 8, there shown an embodiment of the software application 200 as an “App” 650 when executed upon the communication device 110 to design the overall main video clip, also referred to as a “blast”, and then produce it using main editing screens. In FIG. 8a, a main edit screen 660 is shown to illustrate how a video dip overlay is selected with options for style, music or new additions, for example colours. In FIG. 8b, there is shown one layout of a library 665 of videos from different times. By selecting different options via a display 651 generated by the App 600, it is possible to navigate to different edit screens during video production steps. In FIG. 8c, there is shown a manner in which, after a video clip in the library, shown as 665 in FIG. 8b, is selected, it will play in a substantially central position of the display 651, where a back to library button 652 is also shown. In FIG. 8d, there is shows an editing order and pop-up of the one or more video clips recorded. It is possible to press or tap any one of the video clips to preview them. The user can also drag and drop the clip in the edit order arrangement shown in the display 651. This allows for quick and efficient editing of the play order of the video clips which the user is using to build the main video clip. In FIGS. 8e and 8f, there is shown the recording screen where the display 651 has a back button 652, a record button 653, and gives instructions of:

“Tap once to record a 3 second video clip. Hold down to continue recording.”
shown on the display 651. As the recording takes place, a counter beneficially appears in a top right hand corner of the display 651. Video clips recorded are displayed in a foreground 655 of the display 651, allowing the user to see what has been recorded while continuously adding more video clips on the when needed or on-the-run. Furthermore, a “Done button” 656 is also shown in the display 651 of the recording screen. In FIGS. 8g and 8h, there are show the user's video clip screen “My blast screen”, where a video clip can be viewed, posted onto multimedia sites, for example Youtube, Tumblr, Vimeo, Facebook, (which are all registered trademarks) or similar, namely to be commented on by the user and others in a comment area 606, or as a combined screen with a video screen 657, a library 665a of own video clips, namely “blasts”, and other video clips 665b which the user likes.

In one embodiment, the user utilises a camera of a communication device 110, which can be a cellular phone or tablet computer, to record the clip which is then edited using the software, for example by way of an App executed upon computing hardware of the communication device 110. The clip, after it has been edited, may be shared on a TV screen, for example via an Apple TV, (wherein “Apple” is a registered trademark), via a social media site, or sent to other devices for viewing or for performing further editing. It is also possible that a group of users collaborate when producing the video clip, thereby allowing multiple locations to be captured simultaneously and also edited more efficiently. One user can have his/her device 110 as a key editing device, for example using a tablet computer, while multiple devices 110, for example cellular phones, are employed by other users for capturing the video clips, which are sent to the key editing device. This allows for video clips to be generated using multiple sources of, for example, pre-recorded content, live streaming or feeds of clips, output to one or more devices simultaneously over operating platforms such as Android, iOS, Windows8, (which are all registered trademarks) or similar to name some contemporary examples, over home entertainment systems and other communication networks. It is also possible that one key device 110 is used to control when recording is completed but one or more other devices 110. The key recording device 110 is optionally used as the key editing device for some or all of the editing or not at all. This opens up major opportunities for generating user- or location-specific video clips in multiple locations using multiple devices 110. When one device 110 is used to receive data from multiple other devices 110, the one device 110 is beneficially employ for back-end control, namely it operates in a spoke-and-hub model for recording and/or editing to make the video generation process more efficient and also more diverse in location, editing input and collaborative between users.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A video clip editing system (100, 160, 200) employing a mobile wireless communication device (100) including computing hardware (110) coupled to data memory (120), to a touch-screen graphical user interface (130), and to a wireless communication interface (140), wherein the computing hardware (110) is operable to execute one or more software applications (200) stored in the data memory (120), wherein
the one or more software applications (200) are operable when executed on the computing hardware (110) to provide an editing environment on the touch-screen graphical user interface (130) for editing video clips (410, 510) by user swiping-type instructions entered at the touch-screen graphical user interface (130) to generate a composite video creation, wherein a timeline (400) for icons (410) representative of video clips (410) is presented as a scrollable line feature on the touch-screen graphical user interface (130), and icons (510) of one or more video clips (510) for inclusion into the timeline (400) are presented adjacent to the timeline (400) on the touch-screen graphical user interface (130), such that video clips corresponding to the icons (510) are incorporated onto the timeline (400) by said user employing swiping-type instructions entered at the touch-screen graphical user interface (130) for generating the composite video creation.

2. The video clip editing system (100, 160, 200) as claimed in claim 1, wherein the mobile communication device (100) is operable to be coupled in communication with one or more external databases (160) via the wireless communication interface (140), and manipulation of video clips represented by the icons (410, 510) is executed, at least in part, by proxy control directed by the user from the touch-screen graphical user interface (130).

3. The video clip editing system (100, 160, 200) as claimed in claim 1, wherein the one or more software applications (200) when executed upon the computing hardware (110) enables one or more sound tracks to be added to one or more video clips, wherein a duration adjustment of the one or more sound tracks and/or one or more video clips is executed automatically by the one or more software applications (200).

4. The video clip editing system (100, 160, 200) as claimed in claim 3, wherein the one or more sound tracks are adjusted in duration without causing a corresponding shift of pitch of tones present in the sound tracks.

5. The video clip editing system (100, 160, 200) as claimed in claim 3, wherein the one or more software applications (200) executing upon the computing hardware (110) are operable to cause the one or more video clips to be adjusted in duration by adding and/or subtracting one or more image frames from the one or more video clips.

6. The video clip editing system (100, 160, 200) as claimed in claim 5, wherein the one or more software applications (200) executing upon the computing hardware (110) synthesize a new header or start frame (830) of a video clip when a beginning part of the video clip is subtracting during editing.

7. The video clip editing system (100, 160, 200) as claimed in claim 1, wherein one or more software applications (200) executing upon the computing hardware (110) are operable to provide a selection of one or more video clips (510) for inclusion into the timeline (400) presented adjacent to the timeline (400) on the touch-screen graphical user interface (130), wherein the selection is based upon at least one of;
(a) temporally mutually substantially similar temporal capture time of the video clips;
(b) mutually similar subject matter content determined by analysis of the video clips or of corresponding metadata; and
(c) mutually similar geographic location at which the video clips were captured.

8. A method of editing video clips by employing a mobile communication device (100) including computing hardware (110) coupled to data memory (120), to a touch-screen graphical user interface (130), and to a wireless communication interface (140), wherein the computing hardware (110) is operable to execute one or more software applications (200) stored in the data memory (120), wherein said method includes:
(a) executing the one or more software applications (200) on the computing hardware (110) for providing an editing environment on the touch-screen graphical user interface (130) for editing video clips (410, 510) by user swiping-type instructions entered at the touch-screen graphical user interface (130) to generate a composite video creation;
(b) generating a timeline (400) for icons (410) representative of video clip (410) as a scrollable line feature on the touch-screen graphical user interface (130);
(c) generating icons (510) of one or more video clips (510) for inclusion into the timeline (400) adjacent to the timeline (400) on the touch-screen graphical user interface (130); and
(d) incorporating video clips corresponding to the icons (510) onto the timeline (400) by said user employing swiping-type instructions entered at the touch-screen graphical user interface (130) for generating the composite video creation.

9. The method as claimed in claim 8, wherein the method further includes operating the mobile communication device (100) to be coupled in communication with one or more external databases (160) via the wireless communication interface (140), and manipulating video clips represented by the icons (410, 510), at least in part, by proxy control directed by the user from the touch-screen graphical user interface (130).

10. The method as claimed in claim 8, wherein the method includes enabling, by way of the one or more software applications (200) executing upon the computing hardware (110), one or more sound tracks to be added to one or more video clips, wherein a duration adjustment of the one or more sound tracks and/or one or more video clips is executed automatically by the one or more software applications (200).

11. The method as claimed in claim 10, wherein the method includes adjusting a duration of the one or more sound tracks without causing a corresponding shift of pitch of tones present in the sound tracks.

12. The method as claimed in claim 10, wherein the method includes executing the one or more software applications (200) upon the computing hardware (110) to cause the one or more video clips to be adjusted in duration by adding and/or subtracting one or more image frames from the one or more video clips.

13. The method as claimed in claim 12, wherein the method includes executing the one or more software applications (200) upon the computing hardware (110) to synthesize a new header or start frame (830) of a video clip when a beginning part of the video clip is subtracting during editing.

14. The method as claimed in claim 8, wherein the method includes executing the one or more software applications (200) upon the computing hardware (110) to provide a selection of one or more video clips (510) for inclusion into the timeline (400) presented adjacent to the timeline (400) on the touch-screen graphical user interface (130), wherein the selection is based upon at least one of:
(a) temporally mutually substantially similar temporal capture time of the video clips;
(b) mutually similar subject matter content determined by analysis of the video clips or of corresponding metadata; and
(c) mutually similar geographic location at which the video clips were captured.

15. A software application (200) stored on machine-readable data storage media, wherein the software applications (200) is executable upon computing hardware (110) for implementing the method as claimed in claim 8.

16. The software application (200) as claimed in claim 15, wherein the software application (200) is downloadable as a software application from an external database (160) to a mobile communication device for implementing the method.
